(19) United States
(12) Patent Application Publication
(10) Pub. No.: US 2018/0096413 A1
(43) Pub. Date: Apr. 5, 2018

(54) Online Shopping Facilitator Involving All Elements of a Distribution Chain

(71) Applicant: Nauset Solutions, LLC, North Hampton, NH (US)

(72) Inventors: Patrick Preston, North Hampton, NH (US); John Duffy McCarthy, Hampton, NH (US)

(21) Appl. No.: 15/283,798

(22) Filed: Oct. 3, 2016

(51) Int. Cl. G06Q 30/06; G06Q 10/08; G06Q 20/12

(52) U.S. Cl. CPC G06Q 30/0635; G06Q 10/083; G06Q 20/12; G06Q 10/087

(57) ABSTRACT

An online shopping facilitator platform bridges the entire distribution chain from manufacturer to retailer to provide content distribution, fulfillment, distribution chain payment and customer data dissemination to all elements of the distribution chain, as well as customer directed pickup location, with the system ensuring compensation for the entire distribution chain so that no entity in the distribution chain is bypassed.

### FIELD OF INVENTION

This invention relates to an online shopping facilitator that involves the entire distribution chain from manufacturer to retailer and more particularly to a content distribution, fulfillment and data dissemination platform including a customer directed product pickup location system and a system that ensures compensation for the entire distribution chain so that no entity in the distribution chain is bypassed, as well as supplying customer data to all elements of the distribution chain.

### BACKGROUND OF THE INVENTION

One of the current problems with e-commerce in terms of a manufacturer is the ability to reach individual customers and to enable them to purchase goods or services directly without interrupting the manufacturer's distribution chain. Typically if a customer has found a product from a manufacturer which he desires to purchase, calling the manufacture often times results in being passed off to one of the usual elements of the manufacturer's particular distribution chain, as the manufacturer does not want to disturb his relationships with his dealers or distributors by bypassing them.

The manufacturer also may not have a web presence and if the manufacturer has a website it is usually an informational website that does not admit to fulfilling purchases of his company's product.

It is noted that the typical distribution chain first involves the manufacturer selling to a distributor or dealer that could be a retailer, and if product is sold to the distributor, the distributor will then sell it to a retailer and then the retailer sells it to the end-user, namely the consumer. This type of distribution chain does not allow the manufacturer to have control over distribution or presentation of their product for sale in the e-commerce environment. Moreover, if the manufacturer is going to honor its distribution chain contracts, the manufacturer is not able to create a point-of-sale experience for the online sales. Additionally, for those manufacturers that have an information only website, it does not offer a point-of-sale feature. Rather for these situations the system resembles a factory direct model that cuts out distribution.

As will be appreciated, many products require a dealer network distribution to be in place, with the manufacturer developing their distribution network so as to be able to incentivize distributors and dealers to support the particular product involved.

What is described above is a typical brick-and-mortar distribution chain in which if the manufacturer receives a telephone call from a customer he gives the lead to the dealer, with the manufacturer then losing control of that particular lead. They have to put their faith in the dealer going to the customer, where the dealer could potentially sell a competitive product. Moreover, the typical brick-and-mortar distribution chain supports the business model where the manufacturer actually sells to the dealer, with the dealer putting in an order with the distributor and the distributor filling the order by transmitting the product to the dealer or retailer. In this scenario what will transpire is that the lead is directed to a dealer and a dealer is going to sell product to the end-user. Typically the dealer has purchased the product from a distributor, so the distributor is paid automatically by virtue of the dealer having purchased the materials from the distributor in the first place.

Any system that makes the customer directed sales cycle easier without interrupting the rather delicate distribution channel would have to reasonably compensate every element of the distribution channel. In order for the manufacturer to receive an order direct from the customer, a system would have to be devised to compensate all levels of distribution. This would undoubtedly be acceptable to all levels of the distribution because they are obtaining the benefit of sales without having to do any work in obtaining the sale. The type of work involved in maintaining sales is to assure retail stocking and rack space availability, visibility of advertising and tracking of product sales at the retail level. Additionally, distribution provides customer support in the form of returns and other product related issues. This is time-consuming and is a service provided by the distribution chain which is appropriately compensated.

Another issue for the manufacturer is the accessibility to customer data that is useful in any sales and marketing campaign. Ready access to this data is not presently available to all levels of the distribution chain, such that the ability to make further sales decisions is somewhat hampered due to the lack of real time customer information.

Finally, in the dealer/distributor/retailer model, even if the customer wishes to buy direct from the manufacturer, there is no established plan for how the customer is to obtain the product. If a customer calls up the manufacturer to obtain product, usually the best the manufacturer can say to the customer is that it will pass a request on to the distribution chain and will get back as to where you can pick up the product. This is a level of disconnect between the customer and the manufacturer which impedes e-commerce transactions.

There is therefore a requirement to establish a different type of distribution system to facilitate the manufacturer's desire to provide information on the manufacturer's products on an online basis, to be able to provide the product at a customer specified location, to have a central entity collecting funds for the transaction, to have the central entity disbursing the funds throughout the distribution channel, and to provide all levels of the distribution channel with customer information, all under the control of a facilitator platform that functions to coordinate between all of the entities of the distribution chain to provide product availability and advertising, to provide order fulfillment, to provide distribution channel remuneration, and to provide customer data.

### SUMMARY OF THE INVENTION

An online facilitator involving the entire distribution chain provides an online shopping platform that establishes a mutually beneficial online commerce solution between affiliated businesses for the purpose of exposing product to online shoppers, providing customer directed pickup, providing a payment processing system that ensures compensation for the entire distribution chain and a customer data collection system that ensures customer data availability to all elements of the distribution chain. Moreover, the online shopping platform includes contractual obligations to the manufacturer or other entities in the distribution chain to organize and facilitate inventory control so that the availability of certain products at certain locations may be made known to the customer. Additionally, while the subject system is designed specifically for use by manufacturers, any entity in the distribution chain can contract with the online shopping platform to give visibility to the products and services of each distribution chain entity.

How this is accomplished is now described.

First, the online shopping facilitator platform operator contracts with a manufacturer to sell the manufacturer's goods utilizing an e-commerce portal in which the manufacturer informs the online shopping facilitator platform of availability of inventory, it's selling price of the product, the distributor discount, the dealer discount and any other inventory control and payment considerations for the use of the service.

Having been apprised of the manufacturer's relationship its distribution channel the online shopping facilitator platform advertises on the Internet the availability of manufacturer's product and where it may either be shipped, or where it is already on hand. This is an inventory control function of the online shopping facilitator platform.

Thereafter, the platform receives a customer inquiry based on the inventory data and utilizes this request to locate product within the distribution chain and to assure delivery to the particular dealer or retailer that the customer selects.

In this process, the customer is provided with the product data stream using inventory data such that the availability of product within a designated search radius is indicated to the customer. The customer then specifies not only the search criteria for the indicated product, product selection, but also a desired pickup location within the customer defined search radius. Upon receipt of a suitable pickup location, the customer pays for the product or item directly to the online shopping facilitator platform utilizing a check out procedure, with the platform allocating a flow of money to each level of distribution in accordance with a prearranged contract with the manufacturer and its distribution chain. The platform directs an appropriate portion of customer payment to each level of distribution, thereby not cutting out any level of distribution for what now has become a direct manufacturer to customer sale. It will be appreciated that since the platform receives inventory data and customer criteria, the platform generates a product data stream to director of product through distribution.

In this process significant customer data is accumulated and the platform directs customer data to all elements of the distribution chain, including the manufacturer, distributor and dealer/retailer for whatever use these distribution chain elements are able to make of it.

What can be seen is that the customer can be made aware of a manufacturer's product and to be able to buy directly from the manufacturer through the use of the online shopping facilitator platform without disturbing the relationship of the manufacturer to each of the elements of the distribution chain. Moreover, the manufacturer is advised of customer data statistics that enables better forecasting as well as product planning. Not only is a manufacturer made privy to the customer data, so is the distributor and dealer/retailer, so that in addition to getting remunerated for the service that the distribution chain element would normally get, the members of the distribution chain are provided with exceptionally useful and costly customer data that they would ordinarily not be privy to.

In this manner all elements of the distribution chain are accommodated for a direct buy of manufacturer's goods by a customer, an inconvenient if not impossible task given the highly prized manufacturer distribution channels. In this manner all elements of the distribution chain benefit from this so-called direct sale without having to expend marketing and sales effort. The customer is not inconvenienced in the acquisition of the product he or she desires, whereas an added benefit of customer data routing to all elements of the distribution chain provides an added bonus. It will be appreciated that the subject platform also functions as inventory control. It will also be appreciated that any member of the distribution chain can contract with the online shopping facilitator platform for advertising purposes to get their products or services onto the Internet without having to maintain their own marketplace platform, application or toolkit.

In the end, the online shopping facilitator platform provides all of the e-commerce needs of all of the distribution channel players.

### BRIEF DESCRIPTION OF THE DRAWINGS

These and other features of the subject invention will be understood in connection with the Detailed Description in conjunction with the Drawings, of which

FIG. 1 is a diagrammatic illustration of the utilization of an online shopping facilitator platform to facilitate a direct buy from a customer of a product from a manufacturer while at the same time remunerating all elements of distribution so that no element is undercut by the direct sale and also providing both product inventory control and logistics and dissemination of customer data to all elements of the distribution channel; and

FIG. 2 is a flowchart showing the distributed local commerce flow associated with the online shopping facilitator platform of FIG. 1.

### DETAILED DESCRIPTION

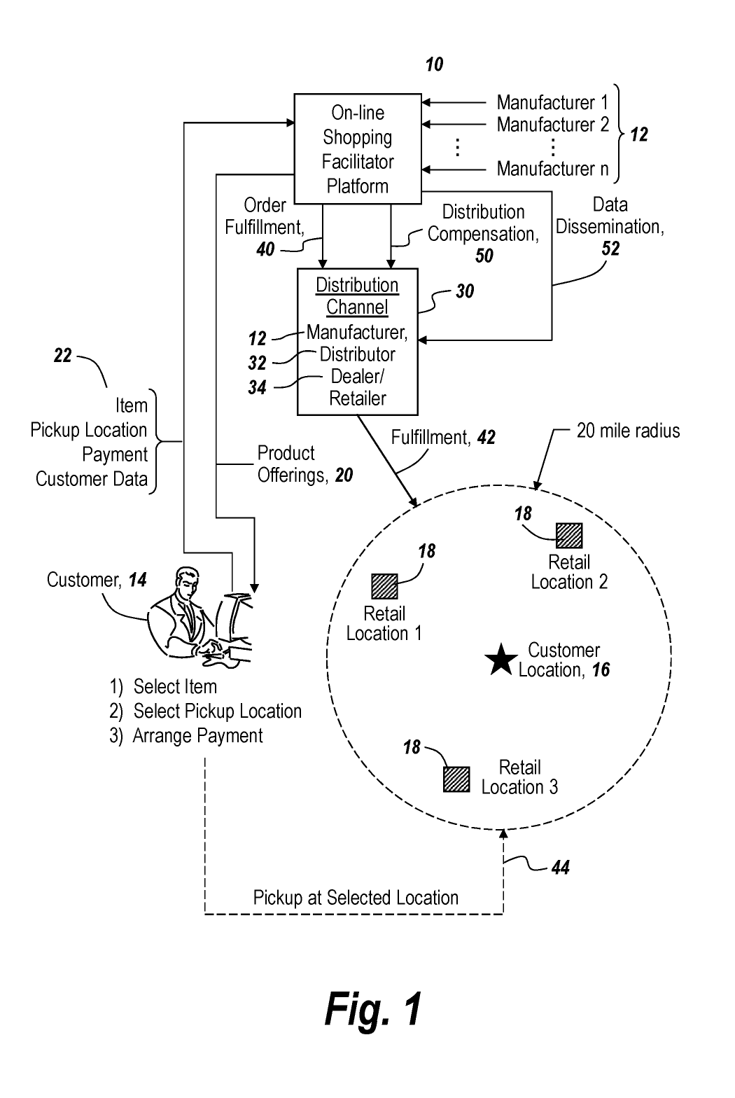

Referring now to FIG. 1, an online shopping facilitator platform 10 is utilized to advertise and sell products or services from one or more manufacturers 12 by offering an online service to a customer 14. The customer is able to order items or services and arrange for pickup as if he were directly communicating with the manufacturer. This online shopping facilitator platform provides online services for manufacturers who do not wish to maintain their own marketplace platform or wish to be able to offer their products or services directly to customers without having to go through distribution. Ordinarily, due to the manufacturer's established distribution channels, the manufacturer would have to refer any incoming inquiry to various levels of the distribution channel or even directly to a dealer/retailer, thereby interposing an additional step in the ordering process. This in turn poses an impediment to the customer's ability to acquire the product or service.

In addition to the ability of the customer to select an item, the customer may indicate a pickup location within a customer defined radius of the customer's location such that when placing an order he may specify which of a number of retail locations 18 he wishes to use as a pickup location. After item selection and pickup location selection the customer arranges for payment through the online shopping facilitator platform 10, with product offerings 20 being illustrated as transmitted from platform 10 to the customer 14 and with item selection, pickup location, payment arrangements and customer data 22 being transmitted to the online platform 10 as illustrated.

It will be appreciated that platform 10 provides an inventory control function since it keeps track of product not only available from the manufacturer but also from any level of the distribution channel here illustrated at 30. It is noted that the traditional brick and mortar distribution channel includes manufacturer 12, a distributor 32 and a dealer/retailer 34.

Upon obtaining an order request, fulfillment initiation 40 is facilitated by the online shopping facilitator platform 10, with product moving through the distribution channel based on the availability of product at each of the levels of distribution. Fulfillment 42 results in the selected product being made available to the designated retail location, ready for pickup by customer 14 as illustrated by dotted line 44.

Key to the ability to maintain the established distribution channel, compensation for each level of distribution 50 is guaranteed by platform 10, i.e. to the manufacturer, to the distributor and also to the dealer/retailer based upon a predetermined discount structure or payment arrangement which tracks the original arrangement of the manufacturer with distribution channel entities. As illustrated at 52, after the transaction between the customer and platform 10, platform 10 distributes customer data collected during the transaction not only to the manufacturer but also to the distributor and dealer/retailer for marketing and sales purposes.

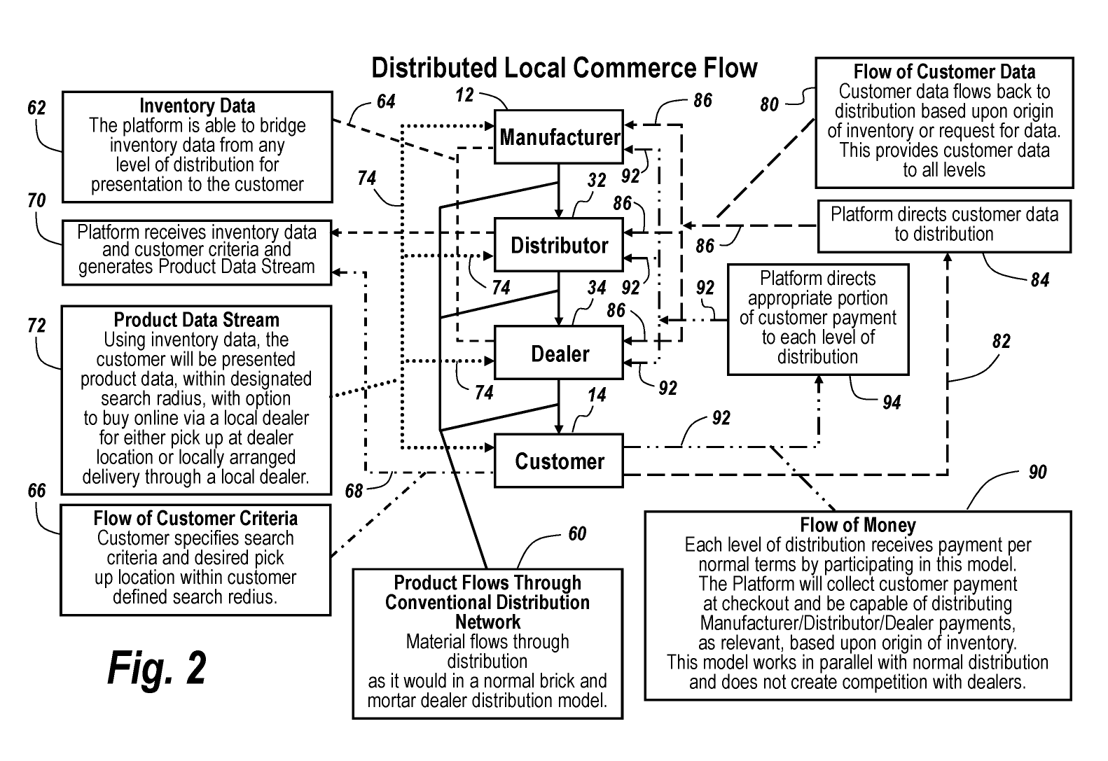

Thus, not only is the customer able to effectively deal directly with the manufacturer to obtain goods and services, a one point payment clearance facility is provided by platform 10 as well as a one point data distribution function, heretofore not available to manufacturers and those in the manufacturer's distribution chain. How this is accomplished is now described in connection with FIG. 2.

Referring to FIG. 2, in which like items are provided with like reference characters, distribution channel 30 is shown to comprise a manufacturer 12, distributor 32 and dealer/retailer 34, with the distribution channel providing product to customer 14. As illustrated at 60, product flows through the conventional distribution network as it would in a normal brick and mortar dealer distribution model. As illustrated at 62, inventory data is made available to the online shopping facilitator platform, with flow of the data illustrated by dotted line 64 to include data to and from the manufacturer, distributor and the dealer/retailer. As illustrated at 66, customer data is specified and includes the specification of pickup location within a customer defined search radius which is selected by customer 14 and is communicated as illustrated by dotted line 68 from the customer to the platform as illustrated at 70. The platform receives inventory data and customer criteria and thereafter generates a product data stream 72. The product data stream is coupled over dotted line 74 not only to the customer but also to the manufacturer, distributor and dealer. Using inventory data, the customer will be presented with product data within a designated search radius, with an option to buy online via a local dealer for either pickup at a dealer location or a locally arranged location through a local dealer. The product data stream enables the fulfillment portion of the subject invention and takes into account availability of product anywhere along the distribution channel to be able to satisfy the customer's request.

As illustrated at 80, customer data flows back to distribution based upon the origin of the inventory that was requested to provide customer data to all levels of distribution. This customer data flow starts with customer 14 as illustrated by dashed line 82, with the platform directing customer data to distribution as illustrated at 84 and dashed lines 86.

As to the flow of payment, and as illustrated at 90, payment from the customer is illustrated by the double dotted dashed line 92 to be held in escrow by the platform as illustrated at 94. Thereafter, the platform directs appropriate portions of customer payment to each level of distribution as illustrated by double dotted dashed line 92. In this manner, no element of the distribution channel is left out in terms of compensation. What this means is that no level of the distribution network is bypassed in a transaction which could, from the consumer's point of view, be characterized as dealing directly with the manufacturer.

It will be appreciated that the online shopping facilitator platform may be accessed not only by the manufacturer but also by the distributor and/or dealer/retailer so as to provide each of these entities with an online presence and e-commerce distribution channel, regardless of whether the distribution channel entity has its own market place platform. The result is that no level of the distribution channel impedes any other level in terms of marketing a product, due to the fact that the online shopping facilitator platform operates as a clearinghouse for all transactions. In short, any of the entities in the distribution channel can take advantage of the online shopping facilitator platform, and while the operation of the system is described in terms of the manufacturer having an online presence provided by the online shopping facilitator platform, this functionality is available to all elements of the distribution channel without stepping on or interfering with other distribution channel entities.

The subject system thus makes it extremely easy for the customer to get product and have it delivered where he or she wants, while at the same time satisfying the economic interests of all levels of the distribution channel and also providing each element of the distribution channel with the customer data that is generated by each of the transactions.

It will be appreciated that inventory control as well as payment completion is key to this process, with inventory data being made available to the platform from all distribution levels. In addition, the individual arrangements for compensation to each level of distribution are provided to the platform. Since inventory data is made available to the platform from each level of distribution and since a customer directed search of this inventory data provides the customer and all levels of the distribution channel with the requisite information, efficient fulfillment of the customer's request results.

The subject platform can also be used to handle customer complaints or returns in accordance with an established policy that is negotiated between all elements of the distribution channel and the owner of the platform. Should the customer wish to return an item at the location at which he or she has picked it up, a return to the dealer/retailer is handled by the platform in the way the manufacturer and distributor normally operates. Thus, not only does the platform serve as a clearinghouse for orders, be they overstock orders, special orders, or regular orders, it also serves as a clearinghouse for returned or damaged items should the manufacturer and the remaining elements of the distribution channel so agree. In this way the customer is given immediate access to customer service by the dealer/retailer at which he or she picks up product. Thus, the subject system gives a customer the confidence that he or she will be accommodated in the same way that the customer would ordinarily be accommodated by a local retailer.

### EXAMPLES

Scenario 1: Establish a platform for a specific market or industry, available to various manufacturers, distributors and dealers within that market to present their customers with an online marketplace to shop for material, within the specific market/industry, for buy-online-pickup-in-store.

Scenario 2: Establish a platform with a broad presence across many markets or industries, available to capture inventory from all levels of distribution, to create a buy-online-pick-up-in-store shopping experience for anything and everything within the online customer's specified radius.

Scenario 3: Establish a platform for a specific distribution entity (manufacturer, distributor, dealer) whereby inventory for that specific entity's distribution footprint is presented to customers for buy-online-pick-up-in-store.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended Claims.

What is claimed is:

1. In a system for compensating all elements of a distribution chain that includes manufacturer, distributor and dealer/retailer, the technological improvement including an online shopping facilitator platform for permitting direct ordering of a manufacturer's products or services without bypassing any element of the distribution chain while at the same time offering an online shopping experience for products or services offered by any one of the elements of the distribution chain, including customer directed product or service pickup, comprising:
an online shopping facilitator platform adapted to interact with one or more manufacturers, distributors and dealer/retailers for providing an online presence for a manufacturer's product or service in which a customer is made aware of the availability of said product or service, said online shopping facilitator platform responding to an order and a specific pickup location for facilitating fulfillment of said order at a customer selected pickup location, for collecting payment for said order, and for arranging payment to each element of said distribution chain from said selected payment such that no element of the distribution chain is bypassed while at the same time permitting the customer to directly order said item or service without having to access any element of said distribution chain.

2. The online shopping facilitator platform of claim 1, wherein said customer transmits customer data to said online shopping facilitator platform and wherein said online shopping facilitator platform disseminates said customer data to all elements of said distribution chain.

3. The online shopping facilitator platform of claim 1, wherein said online shopping facilitator platform is in communication with said manufacturer, distributor and dealer/retailer to maintain inventory data from any level of distribution.

4. The online shopping facilitator platform of claim 3, wherein said platform receives said inventory data and customer criteria and generates a product data stream.

5. The online shopping facilitator platform of claim 4, wherein said product data stream is utilized to fulfill said order.

6. The online shopping facilitator platform of claim 5, wherein said product data stream presents to said customer said product data within a customer designated search radius, with an option to buy said product or service online via a local dealer/retailer for either pickup at said dealer/retailer location or a location locally arranged through said dealer/retailer.

7. The online shopping facilitator platform of claim 1, wherein said fulfillment includes product flowing through said distribution chain in accordance with a brick and mortar dealer distribution model.

8. The online shopping facilitator platform of claim 7, wherein said brick and mortar dealer distribution model includes compensation for said manufacturer, distributor, and dealer/retailer, and wherein said online shopping facilitator platform arranges for compensation for said manufacturer, distributor, and dealer/retailer from funds collected from said customer at the time of said order in accordance with said brick and mortar dealer distribution model.

9. The online shopping facilitator platform of claim 8, wherein said brick and mortar dealer distribution model includes a specific contract between said manufacturer and other elements of said distribution chain delineating distribution chain compensation for the sale of said product or service.

10. The online shopping facilitator platform of claim 1, and further including a contract between said online shopping facilitator platform and one or more elements of said distribution chain for establishing compensation for said one or more elements of said distribution chain upon the placement of an order by said customer and the payment therefor by said customer to said online shopping facilitator platform.

11. The online shopping facilitator platform of claim 1, wherein said online shopping facilitator platform controls product flow through said distribution chain.

12. The online shopping facilitator platform of claim 1, wherein said customer pays for said order directly to said online shopping facilitator platform.

13. The online shopping facilitator platform of claim 12, wherein said online shopping facilitator platform arranges for the compensation to all elements of said distribution chain.

14. The online shopping facilitator platform of claim 1, wherein said customer generates customer data at the time of said order and transmits said customer data to said online shopping facilitator platform.

15. The online shopping facilitator platform of claim 14, wherein said online shopping facilitator platform distributes said customer data to all of the elements of said distribution chain.

16. In a distribution chain including a manufacturer, distributor and a dealer/retailer, the technological improvement of a method for permitting direct ordering of a product or service from a manufacturer without bypassing any element of the distribution chain, comprising the step of:
providing an online shopping facilitator platform operably interconnected to all elements of the distribution chain for obtaining information relating to products and services to be marketed online from one or more elements of the distribution chain, for informing an online customer of the existence of the products and services, for obtaining an order from the online customer as to a product or service and a pickup location for the product and service within a customer defined radius of the customer's location, for receiving payment for the ordered product or service from the customer, for arranging fulfillment of the order through the distribution chain, for arranging compensation to each element of the distribution chain from the proceeds received for said order and for disseminating customer data associated with the order to all elements of the distribution chain.

17. The method of claim 16, wherein the customer is at a customer location, wherein the customer specifies a radius centered on the customer location, wherein the customer is given retail locations relating to the availability of a product or service within the radius, and wherein the customer specifies which of the retail locations within the radius the customer wishes to receive the product or service.
